(19) United States
(12) Patent Application Publication
(10) Pub. No.: US 2021/0174278 A1
(43) Pub. Date: Jun. 10, 2021

(54) MOVING OBJECT ARRANGEMENT APPARATUS

(71) Applicant: TOYOTA JIDOSHA KABUSHIKI KAISHA, Toyota-shi (JP)

(72) Inventor: Osamu SHIMIZU, Okazaki-shi (JP)

(73) Assignee: TOYOTA JIDOSHA KABUSHIKI KAISHA, Toyota-shi (JP)

(21) Appl. No.: 16/999,365

(22) Filed: Aug. 21, 2020

(30) Foreign Application Priority Data
Dec. 9, 2019 (JP) 2019-221930

(51) Int. Cl. G06Q 10/06; G06Q 10/02; G07C 5/08; G07C 5/00; G06Q 50/30

(52) U.S. Cl. CPC G06Q 10/06312; G06Q 10/06315; G06Q 50/30; G07C 5/0816; G07C 5/008; G06Q 10/02

(57) ABSTRACT

In a moving object arrangement apparatus configured to make arrangements for a moving object in response to a request for arrangements from a user terminal, a highly evaluated moving object evaluated equal to or higher than an arranged moving object arranged in response to the request for arrangements is reported to the user terminal as a candidate for an alternative moving object or the highly evaluated moving object is arranged as the alternative moving object when an arrival-not-possible signal indicating that arriving at a destination on board the arranged moving object is not possible is received. As a result, it is possible to restrain a user from feeling unpleasant when the user gets on the alternative moving object.

### CROSS-REFERENCE TO RELATED APPLICATION

This application claims priority to Japanese Patent Application No. 2019-221930 filed on Dec. 9, 2019, incorporated herein by reference in its entirety.

### BACKGROUND

### 1. Technical Field

The present disclosure relates to a moving object arrangement apparatus.

### 2. Description of Related Art

In the related art, as this type of technology, an alternative vehicle guide system including a vehicle for transportation that includes a navigation system, abnormality monitoring means, and vehicle communication means and a communication server system that transmits information about vehicle allocation to the vehicle for transportation has been proposed (for example, refer to Japanese Unexamined Patent Application Publication No. 2000-172992 (JP 2000-172992 A)). In the alternative vehicle guide system, when there is an abnormality in the vehicle for transportation, vehicle-side acquired information obtained by the navigation system or the abnormality monitoring means of the vehicle for transportation is transmitted to the communication server system by means of the vehicle communication means, an alternative vehicle is selected from vehicles that match a condition relating to vehicle allocation information of the vehicle for transportation, and the alternative vehicle is allocated.

### SUMMARY

In the case of the alternative vehicle guide system as above, a user may feel unpleasant when the user gets on an alternative vehicle (when user transfers from vehicle for transportation to alternative vehicle) depending on how the inside of the alternative vehicle is (cleanliness or smell in vehicle).

The present disclosure provides a moving object arrangement apparatus with which it is possible to suppress a possibility that a user feels unpleasant when the user gets on an alternative moving object.

A moving object arrangement apparatus according to an aspect of the present disclosure has adopted the following means.

An aspect of the present disclosure relates to a moving object arrangement apparatus configured to make arrangements for a moving object in response to a request for arrangements from a user terminal. A highly evaluated moving object evaluated equal to or higher than an arranged moving object arranged in response to the request for arrangements is reported to the user terminal as a candidate for an alternative moving object or the highly evaluated moving object is arranged as the alternative moving object when an arrival-not-possible signal indicating that arriving at a destination on board the arranged moving object is not possible is received.

In the case of the moving object arrangement apparatus according to the aspect of the present disclosure, in the moving object arrangement apparatus configured to make arrangements for the moving object in response to the request for arrangements from the user terminal, the highly evaluated moving object evaluated equal to or higher than the arranged moving object arranged in response to the request for arrangements is reported to the user terminal as the candidate for the alternative moving object or the highly evaluated moving object is arranged as the alternative moving object when the arrival-not-possible signal indicating that arriving at the destination on board the arranged moving object is not possible is received. As a result, it is possible to restrain a user from feeling unpleasant when the user gets on the alternative moving object. Here, the “moving object includes a ship or the like in addition to a two-wheeled vehicle, a three-wheeled vehicle, and a four-wheeled vehicle. The “evaluation” may be evaluation (appearance, interior, cleanliness of inside of vehicle, smell inside vehicle, driving attitude of driver, comprehensive evaluation, or like) performed by a general user or evaluation (roughness of driver or like) performed by the moving object arrangement apparatus or a computer other than the moving object arrangement apparatus based on the moving history of a moving object.

In the moving object arrangement apparatus according to the aspect of the present disclosure, a list of the highly evaluated moving objects may be transmitted to the user terminal as candidates for the alternative moving object when the arrival-not-possible signal is received and a highly evaluated moving object matching the result of selection from the highly evaluated moving objects may be arranged as the alternative moving object when the result of selection is received from the user terminal. As a result, the user can select the alternative vehicle from the list of the highly evaluated moving objects.

In this case, a list of lowly evaluated moving objects evaluated lower than the arranged moving object may be transmitted to the user terminal as candidates for the alternative moving object when there is no highly evaluated moving object at the time of reception of the arrival-not-possible signal and a lowly evaluated moving object matching the result of selection from the lowly evaluated moving objects may be arranged as the alternative moving object when the result of selection is received from the user terminal. As a result, the user can select the alternative vehicle even when there is no highly evaluated moving object.

In the moving object arrangement apparatus according to the aspect of the present disclosure, a highly evaluated moving object closest to the user terminal or a highly evaluated moving object evaluated highest may be arranged as the alternative moving object when the arrival-not-possible signal is received. As a result, the user can transfer to the highly evaluated moving object closest to the user terminal or the highly evaluated moving object that is evaluated highest.

In this case, a list of lowly evaluated moving objects evaluated lower than the arranged moving object may be transmitted to the user terminal as candidates for the alternative moving object when there is no highly evaluated moving object at the time of reception of the arrival-not-possible signal and a lowly evaluated moving object matching the result of selection from the lowly evaluated moving objects may be arranged as the alternative moving object when the result of selection is received from the user terminal. As a result, the user can select the alternative vehicle even when there is no highly evaluated moving object.

In the moving object arrangement apparatus according to the aspect of the present disclosure, the arrival-not-possible signal may be a signal attributable to the occurrence of at least one of malfunction of the arranged moving object, a lack of gas that occurs in a case where the arranged moving object is a moving object with an engine, a lack of electric power that occurs in a case where the arranged moving object is an electrified moving object, and a problem of the driver of the arranged moving object.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a configuration diagram illustrating a schematic configuration of an arrangement system including a moving object arrangement apparatus as an example of the present disclosure;

FIG. 2 is an explanatory diagram showing an example of a provided vehicle database;

FIG. 3 is an explanatory diagram showing an example of the flow of processing in a management center, a user terminal, and a provided vehicle (communication terminal);

FIG. 4A is explanatory diagrams showing an example of the flow of processing in the management center, the user terminal, and provided vehicles (communication terminals);

FIG. 4B is explanatory diagrams showing an example of the flow of processing in the management center, the user terminal, and provided vehicles (communication terminals);

FIG. 5A is explanatory diagrams showing an example of the flow of processing in the management center, the user terminal, and the provided vehicles (communication terminals); and

FIG. 5B is explanatory diagrams showing an example of the flow of processing in the management center, the user terminal, and the provided vehicles (communication terminals).

### DETAILED DESCRIPTION OF EMBODIMENTS

Next, an embodiment of the present disclosure will be described by using an example.

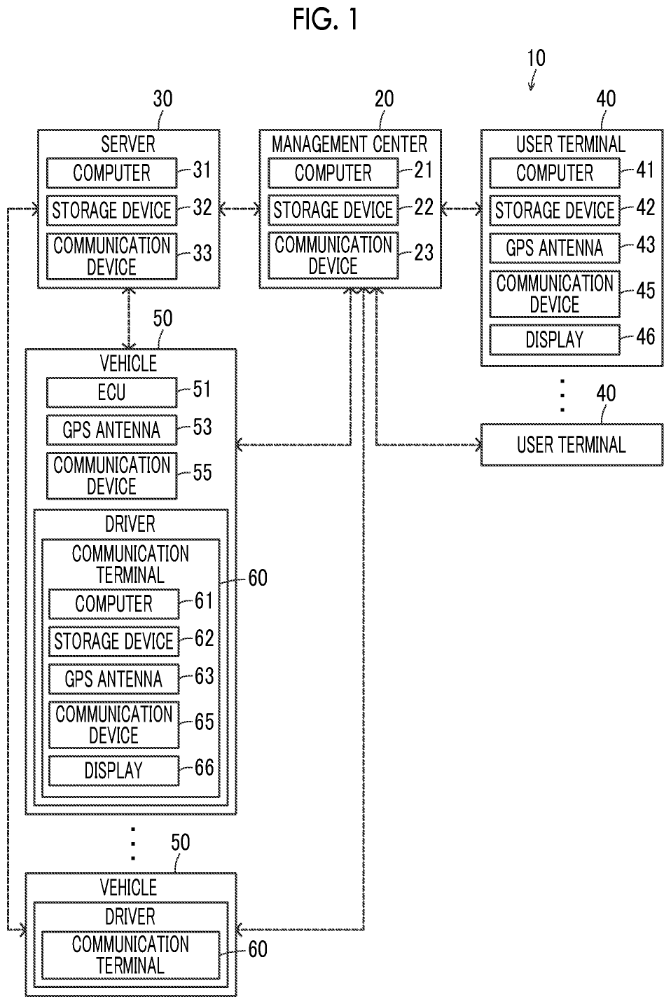

FIG. 1 is a configuration diagram illustrating a schematic configuration of an arrangement system 10 including a moving object arrangement apparatus as an example of the present disclosure. As shown in the drawings, the arrangement system 10 includes a management center 20 that can communicate with user terminals 40 carried by users (customer) or vehicles 50 (including communication terminals 60 carried by drivers of vehicles 50) and a server 30 that can communicate with the vehicles 50 or the management center 20. Mainly, the management center 20 corresponds to a “moving object arrangement apparatus” in the example.

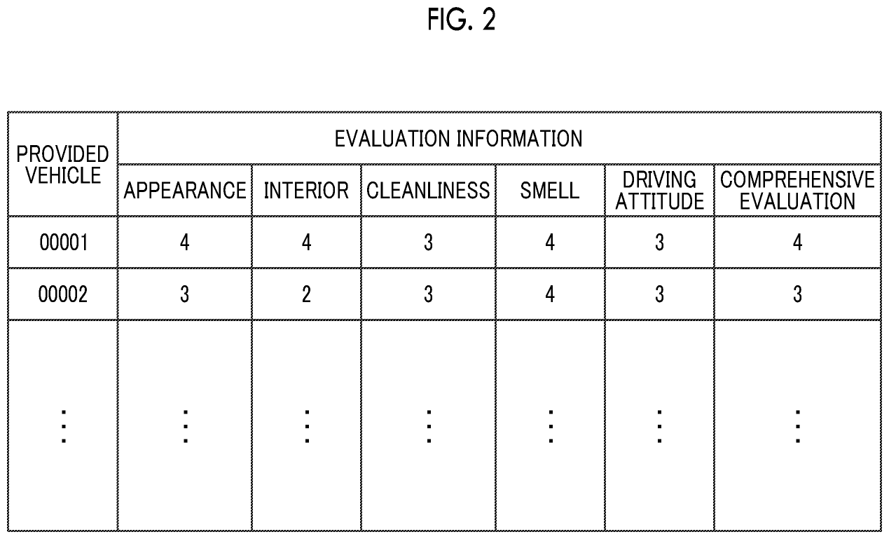

The management center 20 includes a computer 21, a storage device 22, and a communication device 23 that are connected to each other via signal lines. The computer 21 includes a CPU, a ROM, a RAM, an input-output port, a communication port, and the like. The storage device 22 is configured as, for example, a hard disk or an SSD. In the storage device 22, a provided vehicle database, a vehicle allocation program, and the like are stored. The provided vehicle database includes the identification number of a provided vehicle or information about evaluation with respect to the provided vehicle (and driver thereof) performed by a general user. The provided vehicle is a vehicle from among the vehicles 50 that is registered by a provider in the provided vehicle database for a purpose of serving as a driver of the vehicle and allowing a user (customer) to get on the vehicle. FIG. 2 is an explanatory diagram showing an example of the provided vehicle database. In an example shown in FIG. 2, as information about evaluation performed by a general user, the appearance, the interior, the cleanliness of the inside of a provided vehicle, a smell inside the provided vehicle, the driving attitude of a driver, and comprehensive evaluation information are included. Note that, evaluation information items are not limited thereto and, for example, comprehensive evaluation may be performed solely. The vehicle allocation program is a program for allocation of a vehicle matching an arrangement request from the user terminal 40. The communication device 23 performs communication between the computer 21 and the outside thereof.

The server 30 includes a computer 31, a storage device 32, and a communication device 33 that are connected to each other via signal lines. The computer 31 includes a CPU, a ROM, a RAM, an input-output port, a communication port, and the like. The storage device 32 is configured as, for example, a hard disk or an SSD. In the storage device 32, information about the driving history of each vehicle 50 or information about malfunction of each vehicle 50 is stored. The communication device 33 performs communication between the computer 31 and the outside thereof.

Each user terminal 40 is a communication terminal carried by a user (customer) and examples thereof include a smartphone and a tablet terminal. Each user terminal 40 includes a computer 41, a storage device 42, a GPS antenna 43, a communication device 45, and a touch-panel type display 46 that are connected to each other via signal lines. The computer 41 includes a CPU, a ROM, a RAM, an input-output port, a communication port, and the like. The storage device 42 is configured as, for example, a flash memory or the like. In the storage device 42, a vehicle allocation application or the like is stored. The vehicle allocation application is an application program used to make a request for arrangements for a vehicle. A request for arrangements for a vehicle includes information about a boarding place (including current location of user terminal 40) or a destination of the user. The GPS antenna 43 receives position information relating to the current location of the user terminal 40. The communication device 45 performs communication between the computer 41 and the outside thereof. The display 46 is configured to display various items of information and be operable by the user.

Each vehicle 50 is configured as a two-wheeled vehicle, a three-wheeled vehicle, or a four-wheeled vehicle including one or both of an engine (not shown) and a motor (not shown) (for example, common gasoline vehicle, hybrid vehicle, electrified vehicle, fuel cell vehicle, or like). Each vehicle 50 includes an electronic control unit (hereinafter, will be referred to as “ECU”) 51, a GPS antenna 53, and a communication device 55 that are connected to each other via signal lines, in addition to one or both of the engine and the motor. The ECU 51 includes a computer (not shown) including a CPU, a ROM, a RAM, an input-output port, a communication port, and the like. The GPS antenna 53 receives position information relating to the current location of the vehicle 50. The communication device 45 performs communication between the ECU 51 and the outside thereof.

In the example, the driver of each vehicle 50 carries the communication terminal 60. As with the user terminal 40, examples of the communication terminal 60 include a smartphone and a tablet terminal. Each communication terminal 60 includes a computer 61, a storage device 62, a GPS antenna 63, a communication device 65, and a touch-panel type display 66 that are connected to each other via signal lines. The computer 61 includes a CPU, a ROM, a RAM, an input-output port, a communication port, and the like. The storage device 62 is configured as, for example, a flash memory or the like. In the storage device 62, a driver application or the like is stored. The driver application is an application program for registering the vehicle 50 in the provided vehicle database of the management center 20 as a provided vehicle or responding to (accepting/refusing) a request for arrangements for a vehicle from the management center 20. The GPS antenna 63 receives position information relating to the current location of the communication terminal 60. The communication device 65 performs communication between the computer 61 and the outside thereof. The display 66 is configured to display various items of information and be operable by the driver of each vehicle 50.

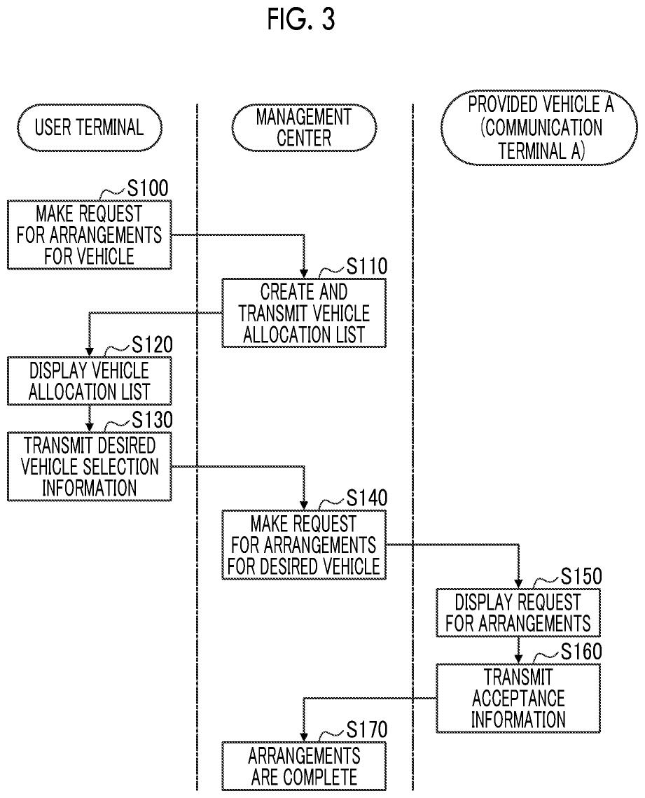

FIG. 3 is an explanatory diagram showing an example of the flow of processing in the management center 20, the user terminal 40, and a provided vehicle A (communication terminal A). The communication terminal A is the communication terminal 60 carried by the driver of the provided vehicle A. In the explanatory diagram in FIG. 3, when a user performs an operation for a request for arrangements for a vehicle by means of the vehicle allocation application in the user terminal 40, the computer 41 of the user terminal 40 transmits the request for arrangements for a vehicle to the management center 20 (step S100). As described above, the request for arrangements for a vehicle includes information about a boarding place or a destination of the user.

When the computer 21 of the management center 20 receives the request for arrangements for a vehicle from the user terminal 40, the computer 21 creates a vehicle allocation list by means of the vehicle allocation program and transmits the vehicle allocation list to the user terminal 40 (step S110). Here, the vehicle allocation list is a list of provided vehicles that are within a first predetermined distance L1 (for example, approximately several km) from the boarding place of the user from among provided vehicles in the provided vehicle database stored in the storage device 22. The creation of the vehicle allocation list is performed by, for example, acquiring position information of each provided vehicle through communication with each provided vehicle in the provided vehicle database and extracting, from the provided vehicle database, the provided vehicles within the first predetermined distance L1 from the boarding place of the user from among the provided vehicles together with information about evaluation performed by a general user.

When the computer 41 of the user terminal 40 receives the vehicle allocation list from the management center 20, the computer 41 causes the display 46 to display the vehicle allocation list by means of the vehicle allocation application (step S120). Then, when the user performs an operation to select the provided vehicle A as a desired vehicle from the vehicle allocation list by means of the vehicle allocation application, the computer 41 of the user terminal 40 transmits desired vehicle selection information (result of selection) to the management center 20 (step S130). In this manner, the user can select the desired vehicle from the vehicle allocation list.

When the computer 21 of the management center 20 receives the desired vehicle selection information from the user terminal 40, the computer 21 transmits, by means of the vehicle allocation program, a request for arrangements for a vehicle to the communication terminal A of the driver (provider) of the provided vehicle A, which is the desired vehicle selected by the user (step S140). When the computer 61 of the communication terminal A receives the request for arrangements for a vehicle from the management center 20, the computer 61 causes the display 66 to display the request for arrangements for a vehicle by means of the driver application (step S150).

Then, when the driver of the provided vehicle A performs an operation for acceptance of the request for arrangements for a vehicle by means of the driver application, the computer 61 of the communication terminal A transmits acceptance information with respect to the request for arrangements for a vehicle to the management center 20 (step S160). When the computer 21 of the management center 20 receives the acceptance information from the communication terminal A, the computer 21 determines that arrangements for a vehicle are completed by means of the vehicle allocation program (step S170).

When the driver of the provided vehicle A accepts the request for arrangements for a vehicle, the driver drives the provided vehicle A to move to the boarding place of the user (pick up the user). When the user gets on the provided vehicle A, the driver drives the provided vehicle A to move to the destination of the user. When the provided vehicle A arrives at the destination, the user gets off the provided vehicle A.

In the example, the user pays a fare to the driver directly or indirectly (via vehicle allocation application, driver application, or management company that performs management or like of managing management center 20) At this time, an allocatable amount of money, which is obtained by subtracting a management company commission from the total fare paid by the user (for example, vehicle allocation fare+base fare+additional fare per unit time or unit distance), is paid to the driver of the provided vehicle A. As a fare system, there may be various cases such as a case where a vehicle allocation fare or a base fare becomes zero, a case where the total fare becomes a fixed far depending on a boarding place and a destination, and a case where various discounts are provided. In addition, there may be various payment methods such as cash payment and cashless payment.

Note that, in a case where the driver of the provided vehicle A performs an operation to refuse the request for arrangements for a vehicle by means of the driver application or performs no operation for a predetermined time when the display 66 is caused by the computer 61 of the communication terminal A to display the request for arrangements for a vehicle by means of the driver application (step S150), the computer 61 of the communication terminal A transmits refusal information with respect to the request for arrangements for a vehicle to the management center 20. Then, processing in step S110 and the subsequent steps is performed again without involving the provided vehicle A.

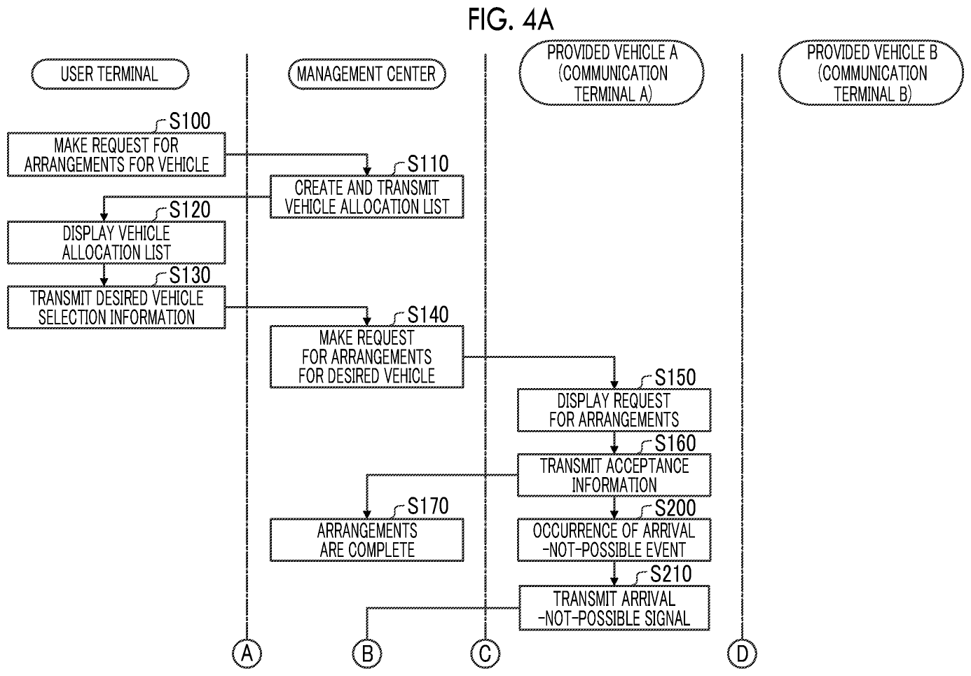

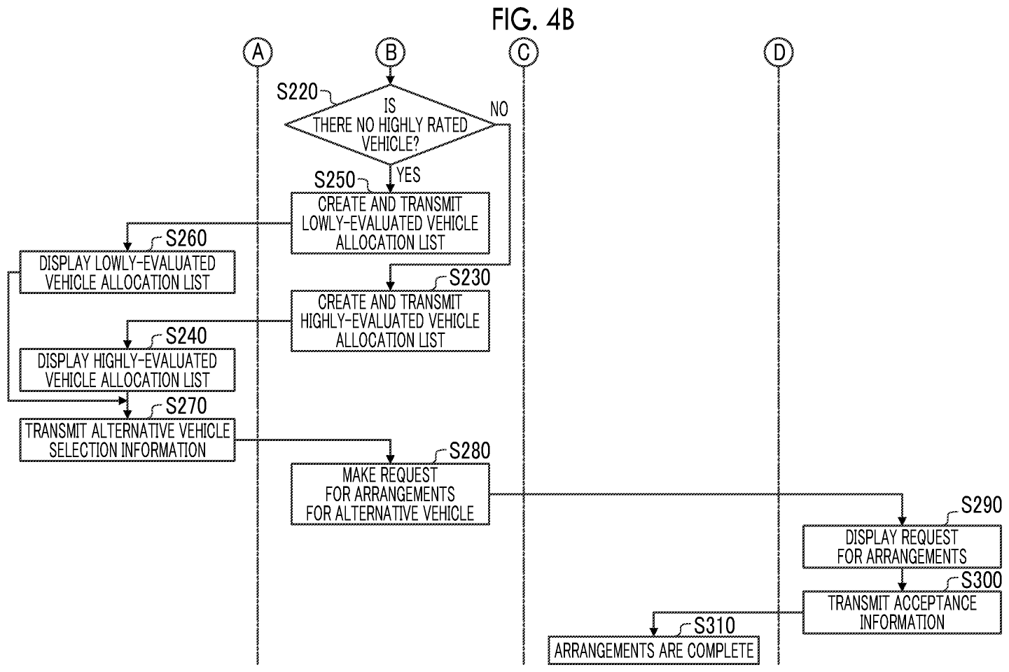

Next, a case where the user becomes not able to arrive at the destination by means of the provided vehicle A will be described. FIGS. 4A and 4B are explanatory diagrams showing an example of the flow of processing in the management center 20, the user terminal 40, provided vehicles A, B (communication terminals A, B) performed at this time. The communication terminal B is the communication terminal 60 carried by the driver of the provided vehicle B. The explanatory diagrams in FIGS. 4A and 4B are the same as the explanatory diagram in FIG. 3 except that processing in steps S200 to S310 is added.

In the explanatory diagrams in FIGS. 4A and 4B, when an arrival-not-possible event where it becomes unable to arrive at a destination occurs during movement to the destination on board the provided vehicle A (step S200), the ECU 51 of the provided vehicle A transmits an arrival-not-possible signal attributable to the occurrence of the arrival-not-possible event to the management center 20 directly or via the server 30 (step S210).

Here, examples of the arrival-not-possible event include malfunction (malfunction that influences traveling) of the provided vehicle A, a lack of gas that occurs in a case where the provided vehicle A is a vehicle with an engine, a lack of electric power that occurs in a case where the provided vehicle A is an electrified vehicle, and the personal circumstances (for example, urgent business) of the driver of the provided vehicle A. In the example, the ECU 51 transmits the arrival-not-possible signal to the management center 20 via the server 30 and malfunction information of the provided vehicle A is stored in the storage device 32 of the server 30 in a case where the arrival-not-possible event is detection of malfunction of the provided vehicle A that is made by the ECU 51 of the provided vehicle A. In addition, the ECU 51 directly transmits the arrival-not-possible signal to the management center 20 in a case where the arrival-not-possible event is detection of a lack of gas or a lack of electric power of the provided vehicle A that is made by the ECU 51. Furthermore, the ECU 51 directly transmits the arrival-not-possible signal to the management center 20 when the driver operates a switch for help (not shown) in the provided vehicle A in a case where the arrival-not-possible event is the personal circumstances of the driver of the provided vehicle A.

When the computer 21 of the management center 20 receives the arrival-not-possible signal of the provided vehicle A from the provided vehicle A or the server 30, the computer 21 determines whether or not a highly evaluated vehicle is present within a second predetermined distance L2 (for example, approximately server km) from the current location of the user by means of the vehicle allocation program (step S220). Here, the highly evaluated vehicle is a provided vehicle that is evaluated equal to or higher than the provided vehicle A by a general user from among the provided vehicles in the provided vehicle database stored in the storage device 22. In the example, determination on whether or not a provided vehicle is a highly evaluated vehicle is made by using the result of comprehensive evaluation in the information about evaluation in the provided vehicle database shown in FIG. 2. Note that, the determination may be made by using the sum or average of values in the items excluding the comprehensive evaluation in the information about evaluation and the determination may be made by using a specific item other than the comprehensive evaluation (for example, item set in advance by user like cleanliness of inside of vehicle).

When the computer 21 of the management center 20 determines that a highly evaluated vehicle is present within the second predetermined distance L2 from the current location of the user in step S220, the computer 21 creates a highly-evaluated vehicle allocation list and transmits the highly-evaluated vehicle allocation list to the user terminal 40 by means of the vehicle allocation program (step S230). Here, the highly-evaluated vehicle allocation list is a list of highly evaluated vehicles that are within the second predetermined distance L2 from the current location of the user from among the provided vehicles in the provided vehicle database stored in the storage device 22. The creation of the highly-evaluated vehicle allocation list is performed, for example, by acquiring the current location of the user or the provided vehicle A through communication with the user terminal 40 or the provided vehicle A (communication terminal 60), acquiring position information of each highly evaluated vehicle through communication with each highly evaluated vehicle in the provided vehicle database and extracting, from the provided vehicle database, the highly evaluated vehicles within the second predetermined distance L2 from the current location of the user from among the highly evaluated vehicles together with information about evaluation performed by a general user. In this manner, it is possible to propose a highly evaluated vehicle to the user as an alternative vehicle candidate.

When the computer 41 of the user terminal 40 receives the highly-evaluated vehicle allocation list from the management center 20, the computer 41 causes the display 46 to display the highly-evaluated vehicle allocation list by means of the vehicle allocation application (step S240). Then, when the user performs an operation to select the provided vehicle B as an alternative vehicle from the highly-evaluated vehicle allocation list by means of the vehicle allocation application, the computer 41 of the user terminal 40 transmits alternative vehicle selection information (result of selection) to the management center 20 (step S270). In this manner, the user can select the alternative vehicle from the highly-evaluated vehicle allocation list. Note that, in a case where the destination is nearby or the like, the user may select no alternative vehicle and get off the provided vehicle A.

When the computer 21 of the management center 20 receives the alternative vehicle selection information from the user terminal 40, the computer 21 transmits, by means of the vehicle allocation program, a request for arrangements for an alternative vehicle to the communication terminal B of the driver (provider) of the provided vehicle B, which is the alternative vehicle selected by the user (step S280). When the computer 61 of the communication terminal B receives the request for arrangements for an alternative vehicle from the management center 20, the computer 61 causes the display 66 to display the request for arrangements for an alternative vehicle by means of the driver application (step S290).

Then, when the driver of the provided vehicle B performs an operation for acceptance of the request for arrangements for an alternative vehicle by means of the driver application, the computer 61 of the communication terminal B transmits acceptance information with respect to the request for arrangements for an alternative vehicle to the management center 20 (step S300). When the computer 21 of the management center 20 receives the acceptance information from the communication terminal B, the computer 21 determines that arrangements for an alternative vehicle are completed by means of the vehicle allocation program (step S310).

When the driver of the provided vehicle B accepts the request for arrangements for an alternative vehicle, the driver drives the provided vehicle B to move to the current location of the user (pick up the user). When the user transfers from the provided vehicle A to the provided vehicle B, the driver drives the provided vehicle B to move to the destination of the user. When the provided vehicle B arrives at the destination, the user gets off the provided vehicle B. Since the user selects the provided vehicle B as the alternative vehicle from the highly-evaluated vehicle allocation list, it is possible to restrain the user from feeling unpleasant when the user gets on the provided vehicle B. Note that, there may also be a case where the user gets off the provided vehicle B before the provided vehicle B comes to pick up the user and the user gets on the provided vehicle B having come to pick up the user thereafter in addition to a case where the user transfers from the provided vehicle A to the provided vehicle B after the provided vehicle B comes to pick up the user.

Examples of a method of allocating an allocatable amount of money to the drivers of the provided vehicles A, B in a case where the user arrives at the destination by transferring from the provided vehicle A to the provided vehicle B include methods as follows. A method in which the allocatable amount of money is allocated at a ratio of the traveling distances of the provided vehicles A, B to the total distance from the boarding place of the user to the destination is conceivable. In addition, a method in which an amount of money obtained by subtracting a vehicle allocation fare or a base fare from the allocatable amount of money is allocated at a ratio of the traveling distances of the provided vehicles A, B to the total distance and the driver of any of the provided vehicles A, B obtains the vehicle allocation fare or the base bare is also conceivable.

When the computer 21 of the management center 20 determines that no highly evaluated vehicle is present within the second predetermined distance L2 from the current location of the user in step S220, the computer 21 creates a lowly-evaluated vehicle allocation list and transmits the lowly-evaluated vehicle allocation list to the user terminal 40 by means of the vehicle allocation program (step S250). Here, the lowly-evaluated vehicle allocation list is a list of lowly evaluated vehicles that are within the second predetermined distance L2 from the current location of the user from among the provided vehicles in the provided vehicle database stored in the storage device 22. A lowly evaluated vehicle is a provided vehicle evaluated lower than the provided vehicle A by a general user from among the provided vehicles in the provided vehicle database. Here, since it is assumed that there is no highly evaluated vehicle within the second predetermined distance L2 from the current location of the user, the vehicle allocation list created in the same manner as in step S110 becomes the lowly-evaluated vehicle allocation list. In this manner, it is possible to propose a lowly evaluated vehicle to the user as an alternative vehicle candidate when there is no highly evaluated vehicle within the second predetermined distance L2 from the current location of the user.

When the computer 41 of the user terminal 40 receives the lowly-evaluated vehicle allocation list from the management center 20, the computer 41 causes the display 46 to display the lowly-evaluated vehicle allocation list by means of the vehicle allocation application (step S260). Then, when the user performs an operation to select the provided vehicle B as an alternative vehicle from the lowly-evaluated vehicle allocation list by means of the vehicle allocation application, processing in step S270 and the subsequent steps is performed. In this manner, the user can select an alternative vehicle from the lowly-evaluated vehicle allocation list even when there is no highly evaluated vehicle within the second predetermined distance L2 from the current location of the user. Note that, the user may select no alternative vehicle and get off the provided vehicle A due to a reason that the destination is nearby or there is no highly evaluated vehicle.

Note that, in a case where the driver of the provided vehicle B performs an operation to refuse the request for arrangements for a vehicle by means of the driver application or performs no operation for a predetermined time when the display 66 is caused by the computer 61 of the communication terminal B to display the request for arrangements for an alternative vehicle by means of the driver application (step S290), the computer 61 of the communication terminal B transmits refusal information with respect to the request for arrangements for an alternative vehicle to the management center 20. Then, processing in step S220 and the subsequent steps is performed again without involving the provided vehicle B.

In the arrangement system 10 in the example described above, when the computer 21 of the management center 20 receives an arrival-not-possible signal of a provided vehicle that a user gets on first from the provided vehicle or the server 30, basically, the computer 21 creates a highly-evaluated vehicle allocation list and transmits the highly-evaluated vehicle allocation list to the user terminal 40. Accordingly, it is possible to propose a highly evaluated vehicle to the user as an alternative vehicle candidate. As a result, it is possible to restrain the user from feeling unpleasant when the user gets on an alternative vehicle. Furthermore, when there is no highly evaluated vehicle, the computer 21 of the management center 20 creates a lowly-evaluated vehicle allocation list and transmits the lowly-evaluated vehicle allocation list to the user terminal 40. Accordingly, it is possible to propose a lowly evaluated vehicle to the user as an alternative vehicle candidate when there is no highly evaluated vehicle.

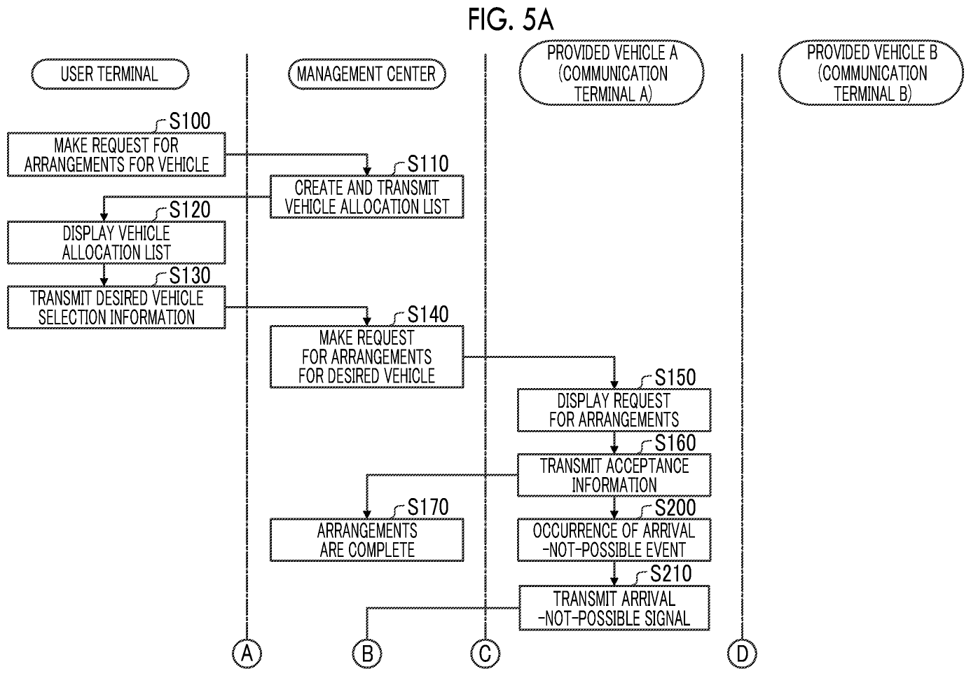

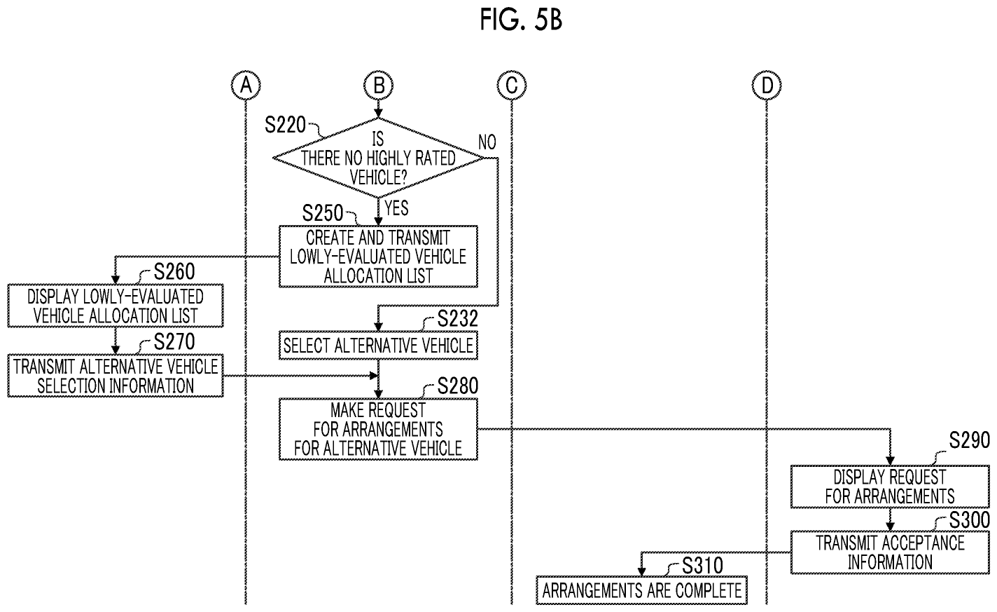

In the arrangement system 10 in the example, the processing in the management center 20, the user terminal 40, the provided vehicles A, B (communication terminals A, B) is performed following the flow shown in the explanatory diagrams in FIGS. 4A and 4B. However, the processing may be performed following the flow shown in an explanatory diagrams in FIGS. 5A and 5B. The explanatory diagrams in FIGS. 5A and 5B are the same as the explanatory diagrams in FIGS. 4A and 4B except that steps S230 and S240 are replaced with step S232.

In the explanatory diagrams in FIGS. 5A and 5B, when the computer 21 of the management center 20 receives the arrival-not-possible signal of the provided vehicle A from the provided vehicle A or the server 30 and the computer 21 determines that highly evaluated vehicles are present within the second predetermined distance L2 from the current location of the user (step S220), the computer 21 selects an alternative vehicle in accordance with a predetermined restriction from the highly evaluated vehicles (step S232). Then, processing in step S280 and the subsequent steps is performed.

Here, the predetermined restriction is a restriction for selecting a highly evaluated vehicle closest to the current location of the user (user terminal 40) from among the highly evaluated vehicles or selecting a highly evaluated vehicle of which the result of evaluation performed by a general user (for example, comprehensive evaluation in information about evaluation in provided vehicle database in FIG. 2) is highest from among the highly evaluated vehicles. In this case, the user can transfer to a highly evaluated vehicle closest to the user terminal 40 or a highly evaluated vehicle that is evaluated highest by a general user from among the highly evaluated vehicles.

In the explanatory diagrams in FIGS. 4A and 4B or FIGS. 5A and 5B, when the computer 21 of the management center 20 receives the arrival-not-possible signal of the provided vehicle A from the provided vehicle A or the server 30 and the computer 21 determines that there is no highly evaluated vehicle within the second predetermined distance L2 from the current location of the user, the computer 21 creates a lowly-evaluated vehicle allocation list and transmits the lowly-evaluated vehicle allocation list to the user terminal 40. However, in this case, information indicating that there is no highly evaluated vehicle within the second predetermined distance L2 from the current location of the user may be transmitted to the user terminal 40 instead of or in addition to creating the lowly-evaluated vehicle allocation list and transmitting the lowly-evaluated vehicle allocation list to the user terminal 40.

In the explanatory diagrams in FIGS. 4A and 4B or FIGS. 5A and 5B, the ECU 51 directly transmits an arrival-not-possible signal to the management center 20 when an arrival-not-possible event occurs during movement to a destination on board the provided vehicle A and the driver operates a switch for help (not shown) in the provided vehicle A in a case where the arrival-not-possible event is the personal circumstances of the driver of the provided vehicle A. However, in this case, the computer 61 of the communication terminal A may directly transmit the arrival-not-possible signal to the management center 20 when the driver of the provided vehicle A performs an operation to make a request for arrangements for an alternative vehicle by means of the driver application of the communication terminal A.

In the arrangement system 10 in the example, the provided vehicle database includes information about evaluation with respect to a provided vehicle performed by a general user in addition to the identification number of the provided vehicle. However, information about evaluation performed by the server 30 based on information relating to the driving history of each vehicle 50 may be included in addition to or instead of the information about the evaluation performed by the general user. For example, there may be a case where determination on whether or not the driver of the vehicle 50 drives recklessly or gently is made by the server 30 using the amount of change in accelerator operation amount or brake operation amount per unit time or information about the degree of acceleration and deceleration of the vehicle as the information relating to the driving history of the vehicle 50 and the more the driver drives gently, the higher the driver is evaluated. In a case where the information about evaluation performed by the server 30 is included in the provided vehicle database, the information about evaluation performed by the server 30 may be added to a vehicle allocation list, a highly-evaluated vehicle allocation list, or a lowly-evaluated vehicle allocation list and determination on whether or not a provided vehicle is a highly evaluated vehicle (whether or not result of evaluation thereof is equal to or higher than provided vehicle A) may be made by using the information about evaluation performed by the server 30.

In the arrangement system 10 in the example, the driver of each vehicle 50 carries the communication terminal 60 and the driver application is stored in the storage device 62 of the communication terminal 60. However, the driver application may be stored in a storage device (not shown) of the ECU 51 of a provided vehicle. In this case, a driver can register the vehicle 50 in the provided vehicle database of the management center 20 as a provided vehicle or respond (accept/refuse) to a request for arrangements for a vehicle from the management center 20 by operating a display or an operation button in the provided vehicle. Therefore, the driver of each vehicle 50 may not need to carry the communication terminal 60.

The arrangement system 10 in the example includes the management center 20 and the server 30. However, the management center 20 and the server 30 may be integrally configured with each other.

In the arrangement system 10 in the example, a provided vehicle is a vehicle from among the vehicles 50 that is registered by a provider in the provided vehicle database for a purpose of serving as a driver of the vehicle and allowing a user (customer) to get on the vehicle. However, a vehicle of which the driver is not a provider, for example, an unmanned vehicle or the like may also be included.

Regarding the arrangement system 10 in the example, a case where the management center 20 makes arrangements for a vehicle in response to a request for arrangements from the user terminal 40 has been described. However, the same may also apply to a case where arrangements for a moving object other than a vehicle (for example, ship) are made in response to a request for arrangements from the user terminal 40.

Since the example is an example for specifically explanatory an embodiment of the present disclosure described in SUMMARY, the correspondence relationship between the main elements in the example and the main elements in described in SUMMARY is not intended to limit the elements according to an aspect of the present disclosure described in SUMMARY. That is, interpretation with respect to the present disclosure described in SUMMARY is to be performed based on the description in SUMMARY and the example is merely a specific example of the present disclosure described in SUMMARY.

Hereinabove, the embodiment of the present disclosure has been described by using the example. However, an applicable embodiment of the present disclosure is not limited to the example and it is a matter of course that various embodiments can be made without departing from the gist of the present disclosure.

The present disclosure can be used in moving object arrangement apparatus manufacturing industry or the like.

What is claimed is:

1. A moving object arrangement apparatus configured to make arrangements for a moving object in response to a request for arrangements from a user terminal, wherein
a highly evaluated moving object evaluated equal to or higher than an arranged moving object arranged in response to the request for arrangements is reported to the user terminal as a candidate for an alternative moving object or the highly evaluated moving object is arranged as the alternative moving object when an arrival-not-possible signal indicating that arriving at a destination on board the arranged moving object is not possible is received.

2. The moving object arrangement apparatus according to claim 1, wherein:
a list of the highly evaluated moving objects is transmitted to the user terminal as candidates for the alternative moving object when the arrival-not-possible signal is received; and
a highly evaluated moving object matching a result of selection from the highly evaluated moving objects is arranged as the alternative moving object when the result of selection is received from the user terminal.

3. The moving object arrangement apparatus according to claim 1, wherein a highly evaluated moving object closest to the user terminal or a highly evaluated moving object evaluated highest is arranged as the alternative moving object when the arrival-not-possible signal is received.

4. The moving object arrangement apparatus according to claim 2, wherein:
a list of lowly evaluated moving objects evaluated lower than the arranged moving object is transmitted to the user terminal as candidates for the alternative moving object when there is no highly evaluated moving object at a time of reception of the arrival-not-possible signal; and
a lowly evaluated moving object matching a result of selection from the lowly evaluated moving objects is arranged as the alternative moving object when the result of selection is received from the user terminal.

5. The moving object arrangement apparatus according to claim 1, wherein the arrival-not-possible signal is a signal attributable to occurrence of at least one of malfunction of the arranged moving object, a lack of gas that occurs in a case where the arranged moving object is a moving object with an engine, a lack of electric power that occurs in a case where the arranged moving object is an electrified moving object, and a problem of a driver of the arranged moving object.
